(19) United States
(12) Patent Application Publication
(10) Pub. No.: US 2024/0026816 A1
(43) Pub. Date: Jan. 25, 2024

(54) HYDROGEN-OXYGEN GAS TURBINE ENGINE

(71) Applicant: Raytheon Technologies Corporation, Farmington, CT (US)

(72) Inventors: Neil J. Terwilliger, Cheshire, CT (US); Walter A. Ledwith, JR., Marlborough, CT (US); Joseph B. Staubach, Colchester, CT (US); David Lei Ma, Avon, CT (US)

(21) Appl. No.: 17/871,581

(22) Filed: Jul. 22, 2022

(51) Int. Cl. F02C 3/30; F02C 3/22

(52) U.S. Cl. CPC F02C 3/30; F02C 3/22

(57) ABSTRACT

An energy supply system includes a source of gas which is at a pressure that is equal to or greater than an atmospheric pressure. The source of gas is configured to deliver the gas into a combustor where it is mixed with a fuel. The combustor is also connected to receive a source of steam. The combustor is operable to provide combustion. Products of the combustion downstream of the combustor are connected to be delivered across a turbine rotor. The turbine rotor is provided with a shaft. The turbine shaft drives a generator. An evaporator downstream of the turbine receives the products of the combustion. The evaporator is operable to heat a source of water. The source of water downstream of the evaporator is the source of steam delivered into the combustor. The gas includes greater than 80% oxygen and the fuel includes hydrogen.

### BACKGROUND OF THE INVENTION

This application relates to a gas turbine engine utilizing pre-pressurized oxygen rich gas delivered into a compressor, and hydrogen as a fuel.

Gas turbine engines are known, and typically include a compressor receiving air. The air is compressed and delivered into a combustor where it is mixed with fuel and ignited. Products of this combustion pass downstream over turbine rotors, driving them to rotate. The turbine rotors in turn drive the compressor rotors.

Gas turbine engines are sometimes utilized to provide electricity such as part of an electric grid. However, known gas turbine engines for providing electricity to an electric grid are somewhat inefficient.

Traditionally, gas turbine engines have used aviation fuel. However, more recently, various alternative fuels have been proposed. One such proposal utilizes hydrogen as a fuel. However, there are challenges with effectively operating such an engine.

### SUMMARY OF THE INVENTION

In a featured embodiment, an energy supply system includes a source of gas which is at a pressure that is equal to or greater than an atmospheric pressure. The source of gas is configured to deliver the gas into a combustor where it is mixed with a fuel. The combustor is also connected to receive a source of steam. The combustor is operable to provide combustion. Products of the combustion downstream of the combustor are connected to be delivered across a turbine rotor. The turbine rotor is provided with a shaft. The turbine shaft drives a generator. An evaporator downstream of the turbine receives the products of the combustion. The evaporator is operable to heat a source of water. The source of water downstream of the evaporator is the source of steam delivered into the combustor. The gas includes greater than 80% oxygen and the fuel includes hydrogen.

In another embodiment according to the previous embodiment, the gas is delivered from the source into a compressor. The compressor is operable to compress the gas prior to it being delivered into the combustor.

In another embodiment according to any of the previous embodiments, the gas is pre-pressurized to the pressure that is greater than the atmospheric pressure prior to be delivered into the compressor.

In another embodiment according to any of the previous embodiments, the gas is at the atmospheric pressure when delivered into the compressor.

In another embodiment according to any of the previous embodiments, a mass flow ratio is defined as a first mass flow across the turbine rotor compared to a second mass flow across the compressor. The mass flow ratio is greater than or equal to 2.0.

In another embodiment according to any of the previous embodiments, the mass flow ratio is greater than or equal to 10.0 and less than or equal to 25.

In another embodiment according to any of the previous embodiments, the compressor is a two stage compressor, and the turbine is a two stage turbine. The energy supply system further includes an intercooler positioned between a first and second compressor stage. The intercooler is provided with water upstream of the evaporator, and is operable to cool the gas intermediate the first and second compressor stage.

In another embodiment according to any of the previous embodiments, an engine pressure ratio is defined as an overall pressure at an exit of the turbine rotor divided by an inlet pressure into the energy supply system, and the engine pressure ratio is between 0.001 and 0.5.

In another embodiment according to any of the previous embodiments, a condenser is positioned downstream of the evaporator. The products of combustion pass through the condenser, and heat the fuel in a line upstream of the combustor.

In another embodiment according to any of the previous embodiments, the condenser removes water from the products of combustion.

In another embodiment according to any of the previous embodiments, the removed water is collected at the source of water.

In another embodiment according to any of the previous embodiments, at least some of the removed water is delivered to an electrolysis system which separates the water into oxygen and hydrogen. The separated oxygen and hydrogen are utilized as the gas and the fuel for the energy supply system.

In another embodiment according to any of the previous embodiments, a steam turbine is configured to receive steam downstream of the evaporator. The steam turbine drives a generator.

In another embodiment according to any of the previous embodiments, the fuel is liquid hydrogen.

In another embodiment according to any of the previous embodiments, the gas is pure oxygen.

In another embodiment according to any of the previous embodiments, the fuel and the steam are premixed in a mixing chamber prior to being delivered into the combustor.

In another embodiment according to any of the previous embodiments, the gas is stored in the source pre-pressurized and delivered directly into the combustor.

In another featured embodiment, an energy supply system includes a source of gas configured to have a gas at a pressure greater than an atmospheric pressure, and configured to deliver the gas into a combustor where it is mixed with a fuel. The combustor is also connected to receive a source of steam. The combustor is operable to provide combustion. Products of the combustion downstream of the combustor are connected to be delivered across a turbine rotor. The turbine rotor is provided with a shaft. The turbine shaft drives a generator. An evaporator downstream of the turbine receives the products of the combustion. The evaporator is operable to heat a source of water. The source of water downstream of the evaporator is the source of steam delivered into the combustor. The gas includes greater than 80% oxygen and the fuel includes hydrogen.

In another embodiment according to any of the previous embodiments, the gas is delivered from the source into a compressor. The compressor is operable to compress the gas prior to it being delivered into the combustor.

In another featured embodiment, an energy supply system includes a source of gas which is at a pressure that is equal to or greater than an atmospheric pressure. The source of gas is configured to deliver the gas into a compressor. The compressor is operable to compress the gas and deliver it into a combustor where it is mixed with a fuel. The combustor is also connected to receive a source of steam. The combustor is operable to provide combustion. Products of the combustion downstream of the combustor are connected to be delivered across a turbine rotor. The turbine rotor is provided with a shaft to drive a compressor rotor. The turbine shaft drives a generator. An evaporator downstream of the turbine receives the products of the combustion. The evaporator is operable to heat a source of water. The source of water downstream of the evaporator is the source of steam delivered into the combustor. The gas includes greater than 80% oxygen and the fuel includes hydrogen.

The present disclosure may include any one or more of the individual features disclosed above and/or below alone or in any combination thereof.

These and other features of the present invention can be best understood from the following specification and drawings, the following of which is a brief description.

### BRIEF DESCRIPTION OF THE DRAWINGS

FIG. 1A shows a first embodiment of an electric supply system.

FIG. 1B shows another embodiment of an electric supply system.

FIG. 2 shows another embodiment of an electric supply system.

FIG. 3 shows another embodiment option with pre-mixing of fuel and steam.

### DETAILED DESCRIPTION

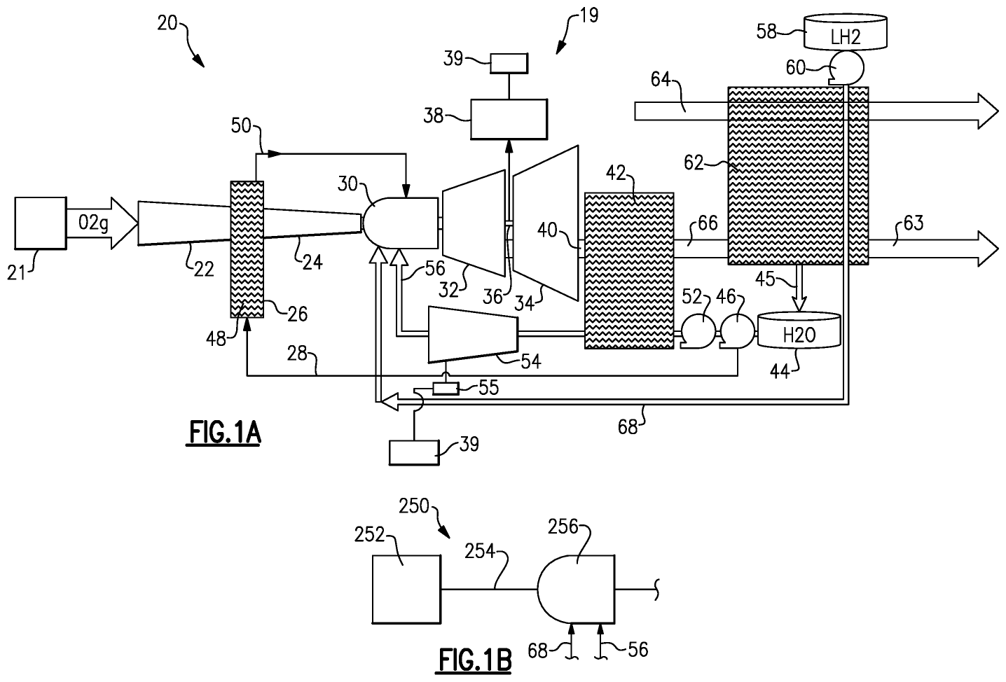

A gas turbine engine 20 as shown in FIG. 1A, as part of an electric storage system 19, incorporates a source of gas 21 (source 21). The gas may be stored in the source 21 at a pre-pressurized pressure above an ambient pressure. In the prior art, the gas delivered into a compressor 24 of the gas turbine engine 20 has typically been air at ambient pressure, or slightly higher pressure if it is downstream of a fan. However, in one embodiment of the present invention, the gas may be pre-pressurized and stored at the source 21.

In embodiments, the gas may be stored on the order of 10,000-15,000 PSI. On the other hand, the gas may also be stored effectively at atmospheric pressure. If stored at atmospheric pressure, a very large storage location may be needed, especially if system 19 is to provide power to a large consumer, such as a power grid. One example storage location could be underground caverns.

In another embodiment 250 shown in FIG. 1B, the gas may be stored as pressurized at 252 and delivered directly into a combustor 256 through line 254. The remainder of FIG. 1A downstream of the combustor 256 could be effectively as shown in FIG. 1A. This embodiment 250 may eliminate a requirement to have compressors 22/24 in the electric storage system 19.

Under each of these options gas could be said to be at a pressure greater than an atmospheric pressure at the location where the engine may be operating.

The gas stored in the source 21 may effectively include pure oxygen, and in embodiments may be include a composition of greater than 80% oxygen. As used in this application “pure oxygen” means equal to, or greater than, 99.99%. By eliminating the nitrogen, which has typically been included in the air delivered into prior art gas turbine engines, the amount of gas which will be oxidized in the combustor 30 is increased, and thus increased energy is provided by the gas turbine engine 20.

The compressor 22 may be associated with a second compressor 24. The gas compressed in the compressors 22/24 is delivered into the combustor 30 where it is mixed with fuel from a line 68, and with steam from a line 56. The fuel in line 68 may be hydrogen. By burning hydrogen and mixed oxygen in the combustor 30 the temperature in the combustor 30 will be quite high. However, by providing steam 56, the temperature becomes manageable.

Downstream of the combustor 30, the products of combustion pass across a turbine 32, and an optional second turbine 34, driving the turbines 32/34 to rotate. A shaft 36 is driven by the turbines 32/34 and in turn drives the compressor rotors 22/24. The shaft 36 drives a generator 38 which produces electricity. The system is described somewhat schematically above. Indeed, in some embodiments, the two-spool engine 20 illustrated with two compressors 22/24 and two turbines 32/34 may include two shafts 36, and each could drive a generator, such as generator 38. The electricity may be utilized such as to power an electric grid 39 to provide power to a community, industrial facility, etc.

Products of combustion 40 downstream of the turbine 34 pass through an evaporator 42. Products of combustion downstream of the evaporator 42 pass at 66 into an optional condenser 62. The condenser 62 heats fuel from a source of hydrogen 58 provided with an optional pump 60. A fluid in line 64 such as air, water, oil, etc. will cool the products of combustion 66. In addition, the products of combustion 66 will be further cooled by heating the fuel in the condenser 62. In embodiments, the condenser 62 is optional and the fuel could be heated by the products of combustion in the evaporator 42.

Water will be removed from the products of combustion in the condenser 62 as shown at 45. The water may be stored at source 44. A pump 46 may deliver the water into an intercooler 48, where it cools the oxygen intermediate the compressor stages 22/24. Line 50 downstream of the intercooler 48 utilizes this heated water. In one embodiment, line 50 is delivered back into the combustor 30 as steam. However, other uses of this steam may benefit from this disclosure such as returning the water or steam in line 50 to the evaporator for further heating before arriving at the combustor through line 56.

Water also passes into a pump 52 and through the evaporator 42. The products of combustion at 40 heat the water in the evaporator 42 such that it becomes steam, and drives a steam turbine 54. Steam turbine 54 may be associated with a generator 55, and may also provide electric power to be sent to the grid 39. At 56, the steam downstream of the turbine 54 passes into the combustor 30.

The use of the steam injected into the combustor 30 assists in the combustor 30 being able to operate with the very high temperatures that will occur with the high oxygen percentages and hydrogen as a fuel.

By utilizing pre-pressurized gas delivered into the compressor 22, the overall pressure ratio of the compressor 22/24 is reduced for a given turbine expansion ratio.

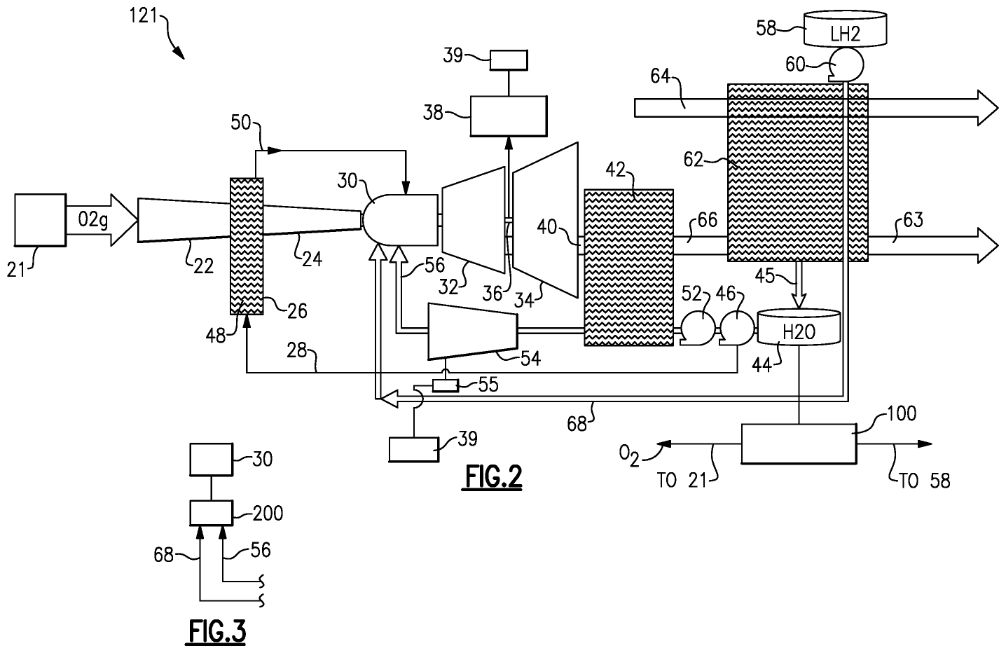

As an example, the overall engine pressure ratio (EPR) of the turbine exit pressure divided by the inlet pressure into the system may be less than 0.5. The EPR is preferably equal to or greater than 0.001. The engine pressure ratio would use the inlet pressure into the compressor in the FIG. 1A embodiment (or the FIGS. 2/3 embodiments) and would use the inlet pressure in the FIG. 1B embodiment.

In addition, since steam is also injected into the combustor 30, the mass flow across the turbines 32/34 is much greater than the mass flow across the compressors 22/24. In embodiments, the mass flow across the turbines 32/34 may be equal to or greater than twice the mass flow across the compressors 22/24.

In embodiments, this mass flow ratio may be equal to or greater than 10, and in other embodiments equal to or greater than 20. In embodiments, the mass flow ratio is less than 25.

By eliminating the volume of nitrogen in the combustor 30 and therefore concentrating the oxidizer, one allows the use of additional steam content, and further increases the energy which can be obtained from the combustion. A line 63 downstream of the optional condenser 62 receives the products of combustion which may be some small fraction of the original products of combustion after the removal of the water at line 45. In embodiments, the source of hydrogen 58 may be liquid hydrogen.

The oxygen and hydrogen may be stored indefinitely such that the energy supply system 19 may be available to supplement the power to grid 39 when the grid 39 otherwise has its electric sources fail to meet the energy demand. That is, the system 19 may be utilized as an emergency or reserve source of electricity that may be relied upon to be available as needed.

As with the oxygen rich gas, the hydrogen may be stored pressurized or at atmospheric pressure.

FIG. 2 shows an embodiment 121 which is generally operable identical to the embodiment 20 of FIG. 1, other than the water from the source 44 is also routed to an electrolysis system 100 which separates the water into oxygen and hydrogen to be delivered back into the system 121 such as the source of gas 21, and the source of fuel 58. In this embodiment, the water cycle is effectively a closed loop.

Any known electrolysis system may be utilized here.

FIG. 3 shows an optional feature wherein the source of steam in line 56 and the source of fuel in line 68 are pre-mixed in a mixing chamber 200 before being delivered into the combustor 30.

It should also be noted that the FIG. 1B embodiment could also be utilized to modify the embodiments of FIGS. 2 and 3.

The use of the systems set forth here eliminates carbon and nitrous oxide emissions, and thus provides valuable benefits.

An energy supply system under this disclosure could be said to include a source of gas which is at a pressure that is equal to or greater than an atmospheric pressure. The source of gas is configured to deliver the gas into a combustor where it is mixed with a fuel. The combustor is also connected to receive a source of steam. The combustor is operable to provide combustion. Products of the combustion downstream of the combustor are connected to be delivered across a turbine rotor. The turbine rotor is provided with a shaft. The turbine shaft drives a generator. An evaporator downstream of the turbine receives the products of the combustion. The evaporator is operable to heat a source of water. The source of water downstream of the evaporator is the source of steam delivered into the combustor. The gas includes greater than 80% oxygen and the fuel includes hydrogen.

Although embodiments of this disclosure have been shown, a worker of ordinary skill in this art would recognize that modifications would come within the scope of this disclosure. For that reason, the following claims should be studied to determine the true scope and content of this disclosure.

1. An energy supply system comprising:
a source of gas which is at a pressure that is equal to or greater than an atmospheric pressure, said source of gas being configured to deliver the gas into a combustor where it is mixed with a fuel, the combustor also connected to receive steam, the combustor being operable to provide combustion, and products of the combustion downstream of the combustor being connected to be delivered across a turbine rotor, the turbine rotor being provided with a shaft, and the turbine shaft driving a generator;
an evaporator downstream of the turbine receiving the products of the combustion, and the evaporator being operable to heat a source of water, and the source of water downstream of the evaporator being the steam delivered into the combustor;
wherein the gas comprises greater than 80% oxygen and the fuel comprises hydrogen;
wherein the gas is delivered from the source into a compressor, and the compressor being operable to compress the gas prior to it being delivered into the combustor;
wherein the compressor is a two stage compressor, and the turbine is a two stage turbine, the energy supply system further comprising an intercooler positioned between a first and second compressor stage, said intercooler being provided with water upstream of the evaporator, and being operable to cool the gas intermediate the first and second compressor stage;
a condenser positioned downstream of the evaporator, the condenser removing removed water from the products of combustion, and part of the removed water being the water provided to the intercooler;
the products of combustion passing through the condenser, and the fuel passing through the condenser in a line upstream of the combustor and the products of combustion heating the fuel; and
wherein some of the removed water is also delivered to an electrolysis system which separates the water into oxygen and hydrogen, and the separated oxygen and hydrogen being utilized as the gas and the fuel for the energy supply system.

2-21. (canceled)
